(19) United States
(12) Patent Application Publication
(10) Pub. No.: US 2016/0165906 A1
(43) Pub. Date: Jun. 16, 2016

(54) Line without checkweigher between slicing and packaging machine

(71) Applicant: GEA Food Solutions Germany GmbH, Biedenkopf-Wallau (DE)

(72) Inventor: Bernd Lasslop, Kempten (DE)

(21) Appl. No.: 14/778,370

(22) PCT Filed: Jan. 16, 2014
(86) PCT No.: PCT/EP2014/050834

§ 371 Date: Sep. 18, 2015

(30) Foreign Application Priority Data
Mar. 21, 2013 (DE) 10 2013 205 043.7

(51) Int. Cl. A22C 17/00; A23C 19/14; B65B 57/10

(52) U.S. Cl. CPC A22C 17/0086; B65B 57/10; A23C 19/14

(57) ABSTRACT

The present invention relates to a line and method for slicing food bars, having: a scanner which determines, for each food bar, data relating to the internal and/or external structure, a slicing device which divides the food bar into portions on the basis of the data from the scanner, and a packaging machine which packages respective portions into packaging.

The present invention relates to a line and a method for cutting blocks of food, having:
a scanner which acquires data about the internal and/or external structure from each block of food,
a cutting apparatus which divides the block of food into portions on the basis of the data from the scanner,
a packaging machine which packs respective portions into a package.

The lines of this generic type are known from the prior art and are used for the purpose of cutting blocks of food, for example blocks of sausage, cheese, ham or the like, into portions which are generally made up of several slices of food. In the process, the respective weight of the block of food is initially determined using a set of scales according to the prior art. A scanner, for example an x-ray scanner, is then used to determine the local weight distribution, for example within the block of food, and this data is then used to divide the block of food into portions which are of as precise a weight as possible. In order to determine whether the weight of the portion corresponds to the desired weight, a set of scales which weighs each portion is arranged downstream of the cutting machine. The result of this weighing process is used to calibrate the scanner, that is to say to correct the local weight distribution and/or to control the cutting process, as backwardly directed control. However, this method is at the same time very complicated, in particular in the case of multi-lane cutting of several, blocks of food, because a multi-lane, dynamic set of scales is required for this purpose. In addition, the line is therefore longer and often can only be accommodated in the narrow production halls with difficulty.

Furthermore, when cutting the blocks of food, care must be taken to select the number and the thickness of the slices of food in a portion such that the cut portions correspond to the regulations relating to prepacked goods. In order to ensure this, food manufacturers specify a target weight which is above the nominal weight, so that the packages on average contain more product than is indicated on the package. The costs of this so-called “giveaway” cannot be passed on from the food manufacturers to the consumers, and therefore it is desirable on the part of the food manufacturers for the target weight of a package to be above the nominal weight indicated on the package by as small an amount as possible, but this is only possible using a line which keeps the required target weight within very small tolerances. If these narrow tolerances are not compiled with, the packages have to be corrected manually, this entailing increased expenditure and possibly hygiene problems for the manufacturer. In addition, the “giveaway” will increase since only whole slices can be added to the underweight packages.

After cutting, the respective portions are placed into packages and the package is then closed. A checkweigher is then used to once again determine the weight of the respective ready package in order to determine that the packages correspond to the regulations relating to prepacked goods.

The object of the present invention was to provide a line and a method for cutting blocks of food into portions which are of as precise a weight as possible and then packing the respective portion into packages, which line and method are to be simple and cost-effective and in which the “giveaway” is minimized.

The object is achieved by a line for cutting blocks of food, having:
a scanner which acquires data about the internal and/or external structure from each block of food,
a cutting apparatus which divides the block of food into portions on the basis of the data from the scanner,
a loading unit for automatically or manually placing the portions into packaging recesses in a packaging machine,
a packaging machine which packs respective portions into a package,
wherein no set of scales is provided between the cutting apparatus and the packaging machine.

It was certainly surprising to a person skilled in the art and not to be expected that even though the set of scales following the cutting machine and downstream of the packaging machine has been dispensed with, portions which are extremely accurate in terms of weight are cut even though the feedback signal about the actual weight of the respective package is available only with a long, often minute-long, delay. The “giveaway” in the case of the line according to the invention is smaller than in the case of lines according to the prior art. Since the set of scales, which has to be designed as a so-called dynamic set of scales with which the weight of the respective portion is determined as it is being conveyed, following the cutting machine can be dispensed with, the line according to the invention can be designed in a significantly simpler, shorter and more economical manner. The line according to the invention rarely requires servicing. The weight of the respective portion, including the packaging, is determined only at the end of the line and the result of this weighing process may be used to calibrate the scanner, the evaluation of the measurement results of said scanner and/or to control the cutting machine.

In a preferred embodiment of the present inventions, it is even possible to dispense with determining the weight of the block of food before or after scanning and/or before cutting. The line according to the invention operates in an extremely stable manner and, for example, when cutting cheese, in particular hard cheese, for example Dutch cheese or Leerdammer, can reduce the “giveaway” almost to zero. It is no longer necessary to add anything to the individual portions, and therefore the packing of said portions is more hygienic and less complicated.

These statements made in respect of the line according to the invention also apply to the method according to the invention, and vice versa.

The present invention relates to a line for cutting blocks of food into a large number of portions which are then packed using a packaging machine.

A block of food is preferably a block of sausage, cheese or ham. These blocks of food often have a substantially constant cross section. The blocks of food, such as a sausage, are generally elongate, that is to say their cross section is substantially smaller than their length. The slices of food are generally cut off perpendicular to the longitudinal axis of the block of food. However, the block of food may also be a natural ham or a block of food which is made up of several parts.

Data about the internal and/or external structure of the block of food are initially determined using a scanner, wherein the external structure is, in particular, the periphery of the block of food and the internal structure is, in particular, the local density of said block of food. Suitable scanners include optical scanners which are based, for example, on laser and/or photocell technology and/or irradiation scanners which also determine the internal structure of the block of food. The scanner is preferably an X-ray scanner.

The scanner can be arranged upstream of the cutting apparatus or be part of the cutting apparatus.

The blocks of food are preferably examined slice by slice using an irradiation scanner. This irradiation scanner, for example an X-ray scanner, has a radiation source and a, for example photosensitive, sensor which is situated on respectively opposite sides of the periphery of the block of food. This sensor is, for example, a line scan camera. The radiation source emits rays which enter on one side of the periphery of the block of food, penetrate the entire width of the block of food, and are received on the opposite side by the sensor. This sensor measures the intensity of the received rays which are attenuated when passing through the block of food, wherein the attenuation is dependent on the local state of the block of food, for example the density of said block of food. The irradiation takes place over the entire width of the product, wherein preferably only one value, which is particularly preferably integrated with respect to the entire width of the product, is determined for each scan slice. The irradiation scanner is preferably provided at a fixed location, and the block of food is conveyed, preferably along its longitudinal axis, through the irradiation scanner. In this case, the block of food is situated, for example, on a conveyor belt which is arranged between the radiation source and the sensor. The block of food is irradiated slice by slice, wherein the slices are preferably arranged perpendicular to the longitudinal center axis of the block of food. The desired thickness of a slice of this kind, which is called a “scan slice”, is dependent on the desired measurement accuracy. The thickness of the scan slice is preferably less than that of the slice of food which is to be cut off from the block of food, however. The thickness of the scan, slice is preferably ≦⅕, particularly preferably ≦ 1/10, of the thickness of the slice of food which is actually out off. The thickness of each scan slice is preferably the same. The irradiation scanner measures n values p_{i,i-1-n} from n scan slices, wherein the respective value is preferably an integral with respect to the width of the product for portioning with a precise weight. The values respectively measured by the sensor are stored in the computer unit, preferably depending on their respective position in the longitudinal direction of the block of food. The computer unit can be provided in the irradiation scanner or in a downstream slicer or in another CPU. This storage can be performed using single values. However, the measured values preferably set a curve and this curve is stored. It is further preferably also possible to interpolate between two respective values. The computer unit accordingly preferably knows which measured value has been determined at which point along the longitudinal axis of the block of food. If a uniform scan slice thickness is not being used, the respective thickness of the scan slice additionally needs to be recorded and stored and taken into account when determining the curve.

Once a block of food has been fully scanned, the sum P of all the values which are determined by the sensor is preferably formed. If the thicknesses of the scan slices is not uniform, it may be advantageous if a sum which is weighted with the slice thickness is formed. The sum is likewise stored.

The block of food is then preferably transferred, with the same orientation as that in which it was examined, to a cutting machine which divides it into portions. A particular length x_{N} has to be cut off from the block of food for each portion, said length corresponding to the desired target weight G of the respective portion, wherein a portion comprises at least one slice, preferably a plurality of slices, of food. The cuts made by the slicing machine are made substantially parallel to the direction of irradiation of the irradiation scanner and are preferably arranged substantially perpendicular to the longitudinal center axis of the block of food. If this is not the case, the respective data record has to be mathematically corrected. The starting position of the block of food during cutting preferably corresponds as exactly as possible to the starting position during scanning so that the longitudinal coordinates which are stored during scanning match the longitudinal coordinates during cutting.

The data which is provided by the scanner and also the desired target weight G of the respective portion are used to calculate the length (x_{N}) which is to be cut off from the block of food in each case.

To this end, a factor k is initially calculated by dividing the weight W of the block of food by the sum P of all of the measured signals from the scan slices.

The factor k can then be used to convert the measured value p_{i,i=1-n} into the weight of each scan slice. These values are added for each portion until the desired target weight G of the portion is reached. On the basis of the number of added scan slices multiplied by the thickness of the scan slices, the computer unit knows what length x_{N} has to be cut off from the block of food for the respective portion. This process is preferably repeated for each portion until the block of food has been cut up. The target weight can also be calculated differently from block of food to block of food in order to obtain as large a number of complete and correctly weighted portions as possible within the guidelines and in the process to avoid an incomplete last portion or remaining slices. The respective values are transferred from the computer unit to the cutting machine which is controlled on the basis of this value. A person skilled in the art will understand that the product length which is to be cut off for each portion can also be calculated in a computer unit or another CPU which is associated with the slicer and receives data from the irradiation scanner and transmits data to the slicer.

As an alternative, it is also possible to calculate what number of measured values is required for each portion. The measured values pᵢ are then added up for each portion until the desired number of measured values for the portion is reached. On the basis of the number of added scan slices multiplied by the thickness of the scan slices, the computer unit knows what length x_{N} has to be cut off from the block of food for the respective portion. This process is repeated for each portion until the block of food has been sliced. The respective values are transferred from the computer unit to the cutting machine which is controlled on the basis of this value. A person skilled in the art will understand that the product length which is to be cut off for each portion can also be calculated in a computer unit or another CPU which is associated with the slicer and receives data from the irradiation scanner and transmits data to the slicer.

According to a further preferred embodiment, the measured values are combined to form a curve. In order to determine what length (x_{N}) has to be cut off from the block of food for the respective portion, a plurality of integrals, in particular, are calculated beneath the curve. In this case, the desired weight of the respective portion is prescribed and the integral is used to determine what length (x_{N}) has to be cut off from the block of food for said portion. The entire calculation very particularly preferably takes place for all of the portions of a block of food before the block of food is cut or while said block of food is being cut.

The length (x_{N}) which is to be cut off from the block of food can be cut into a prescribed number of slices of food. This then results in the thickness of the slices of food which are to be cut off for the respective portion.

As an alternative, a particular range of thickness of the slices of food is predetermined. The computer unit then calculates how many of these slices of food are cut off from the block of food, and the precise thickness of said slices, for each portion.

The slicer has a moving, in particular rotating, blade. The block of food is situated on a conveyor means which conveys the block of food in the direction of the blade which cuts off slices of food from the front end of the block of food. In this case, the thickness of a slice is determined by the length with which the block of food is conveyed between two sections. Once the respective slice of food has been cut off from the block of food, several slices of food are generally configured to form a portion which is then packed. The respective portion is generally created on a set-down table onto which the slices of food fail after having been cut off.

According to the prior art, these portions were then weighed and the signal from the set of scales was used to control the cutting process and/or to calibrate the scanner. This weighing operation is now dispensed with according to the invention. There is no set of scales, which determines the weight of each portion before they are packed, between the packaging machine and the slicer.

The block of food is preferably cut in several lanes, that is to say several blocks of food are cut at least temporarily at the same time. In the event of a complete movement of the cutting blade, several slices of food are cut off from the blocks of food at the same time. In this case, each black of food has its own conveying means which is conveyed in the direction of the cutting blade and can control said cutting blade individually. According to the prior art, a checkweigher was then associated with each lane, said checkweigher having determined the weight of the respective portion in the respective lane before said portion was packed. This set of scales is now dispensed with according to the invention.

After being cut, the respective portion is transferred to a packaging machine and in each case placed into a package by a loading unit, for example a feed belt, a robot and/or manually, said package then being closed. The packaging machine may be a form-fill-seal packaging machine, for example a so-called thermoformer, or a tray sealer or any other packaging machine which is known to a person skilled in the art. According to the invention, neither the weight of the individual cut slices of food nor the weight of the ready portion is determined between the cutting machine and the packaging machine. Surprisingly, this weighing step can be dispensed with at this point.

If required, the ready packages are further separated and then particularly preferably individually conveyed on.

According to the invention, a checkweigher which determines the weight of the respective package and transmits the weight preferably to a computer unit is provided downstream of the packaging machine. This data can later serve as proof of the produced packages having corresponded to the regulations relating to prepacked goods. The signal from the checkweigher can fee used to calibrate the irradiation scanner, to correct the evaluations of the signals from the irradiation scanner and/or to control the cutting machine, even though the weight of the packaging machine is included. This was not expected by a person skilled in the art. A checkweigher within the meaning of the invention is any means with which the weight of the respective portion can be sufficiently precisely determined. Said checkweigher is preferably actually a set of scales. The set of scales can have a single lane or multiple lanes, wherein a single-lane set of scales is sufficient however.

According to this preferred embodiment of the present invention, the weight of the ready package (=weight of the portion+packaging material) is accordingly determined once at the end of the line according to the invention. This value can be transmitted to a computer unit in the form of an individual value, in the form of a sum or in the form of an average value of several individual values of a block of food. This measured value can be used to calibrate the scanner, in particular the irradiation scanner, to correct the evaluation of the signals from the irradiation scanner and/or to control the cutting machine.

Although the actual weight of the respective package is first measured with a very long time delay, portions with a very low “giveaway” are nevertheless cut off. The line according to the invention runs in a very stable manner. The signal from the checkweigher can also be used to draw a conclusion about the weight of the next block of food which is to be cut.

In a preferred embodiment of the present invention, the line has a means with which the movement of the respective Portion within the line can be tracked at least in sections. This preferred embodiment of the present invention is of particular interest when several blocks of food are cut in parallel. It is then possible to trace which portion originates from which block of food and/or which lane. In particular, the weight of a ready package, which weight is determined at the checkweigher, can be associated with a specific block of food and/or the weight of all of the packages whose contents originates from one block of food can foe added for example. However, this data can also be important for subsequent complaints if the manufacturer has to prove which goods were contained in the respective package.

The line according to the invention preferably has a computer means which at lease temporarily stores and/or further processes the data from the irradiation scanner and/or data from the checkweigher. This computer means may be a separate component or be integrated in one of the existing assemblies. The computer means can comprise several parts which are interconnected. The computer means is preferably also used to control the line overall and/or the individual assemblies of said line, such as the irradiation scanner, the cutting machine and/or the packaging machine for example.

A further subject matter of the present invention is a method for cutting blocks of food precisely in respect of weight using a line having:
a scanner which acquires data about the internal and/or external structure from each block of food,
a cutting apparatus which divides the block of food into portions on the basis of the data,
a loading unit for automatically or manually placing the portions into packaging recesses in a packaging machine,
the packaging machine which packs the respective portions into a package, and
a checkweigher which is provided downstream of the packaging machine and which determines the weight of the respective package,
wherein the signal from this checkweigher is used to control the cutting apparatus and/or to calibrate the scanner for the next block of food which is to be cut.

The statements made in respect of this subject matter of the present invention equally apply for the other subjects of the present invention, and vice versa.

A line is preferably provided with:
a scanner, in particular a radiation scanner, which acquires n data P_{i,i=1-n} from n scan slices with a thickness x_{i,i=1-n} which are arranged one behind the other along the longitudinal axis (x),
a cutting apparatus which divides the block of food into portions on the basis of the data P_{i,i=1-n},
a packaging machine which packs respective portions into a package, and
a checkweigher which is provided downstream of the packaging machine and which determines the weight of the respective package,
in which the signal from this checkweigher is used to control the cutting apparatus, to calibrate the irradiation scanner and/or to calculate a weighting factor (k) for the next block of food which is to be cut.

The sum S of the weights of ail n portions of in each case one block of food is preferably calculated. The sum of all measured n data P_{i,i=1-n} of this block of food is preferably calculated. A quotient, the weighting factor, is particularly preferably calculated from the sum S and the sum of all n values. This weighting factor can be used to calculate the length which is to be cut from the next block of food for the respective portion in each case, without having to measure the weight of said block of food. It is possible, under certain circumstances, to save a method step and/or an additional set of scales by virtue of this preferred embodiment of the present invention.

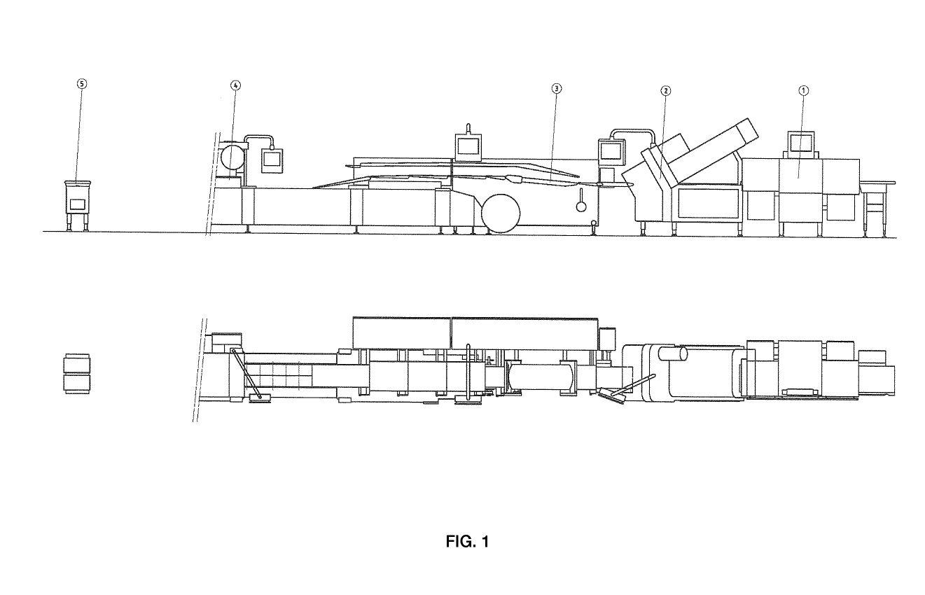

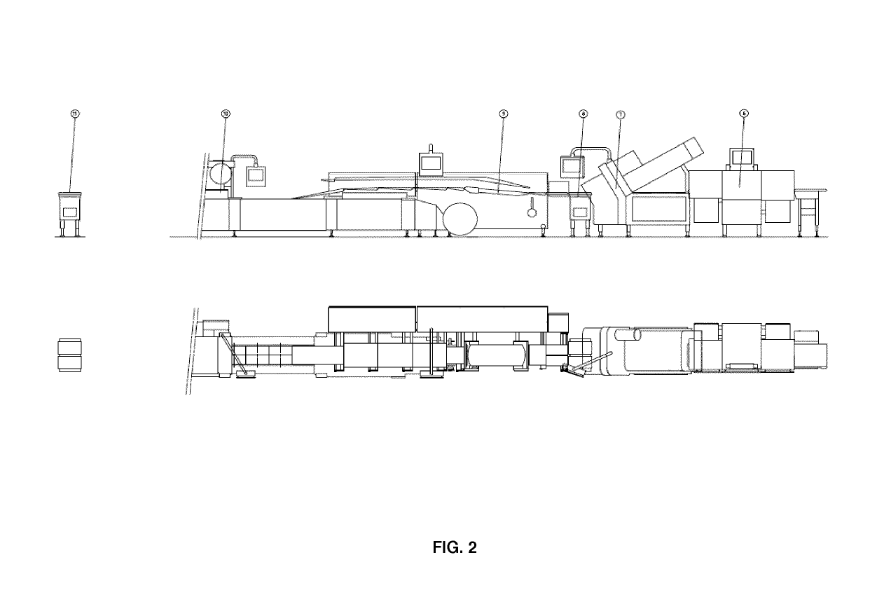

The inventions will be explained below with reference to FIGS. 1 and 2 and one example. These explanations are merely exemplary and do not restrict the general inventive concept. The statements made apply to all of the subjects of the invention equally.

FIG. 1 shows the line according to the invention.

FIG. 2 shows a line according to the prior art.

FIG. 2 shows a cutting line according to the prior art in which blocks of food are cut into slices of food and portions of as precise a weight as possible are produced in the process. A block of food is initially weighed using a set of scales and then conveyed through the irradiation scanner 6, preferably an X-ray scanner, by way of a feed belt. The block of food can also be weighed after the scanning process. However, the weight of the respective block of food may also be known already, and therefore the weighing process can be dispensed with. The product is scanned slice by slice in the scanner 6. In the present case, the external structure, the periphery in this case, and the internal structure, the local density in this case, are determined in the process. After the block of food has been scanned, it is loaded into the cutting machining 7, in this case a so-called high-performance slicer, by means of the feed conveyor belt. The cutting apparatus is generally provided with multiple lanes, that is to say several products can be cut at the same time. The data which is acquired by the irradiation scanner is transferred either directly to the cutting apparatus or to another control unit/CPU where it is further processed if required. The cutting process in the cutting apparatus is now controlled on the basis of the data which is acquired during scanning such that portions of as precise a weight as possible are produced. After cutting, the respective portions of food, which are generally made up of several slices of food, are transferred to a weighing apparatus 8, in particular a dynamic set of scales, according to the prior art in order to check whether the desired target weight has been complied with. The weighing apparatus is of multi-lane design, wherein the number of lanes in the cutting apparatus corresponds to the number of lanes in the weighing apparatus. This data is then used to calibrate the data evaluation of the irradiation scanner and/or to control the cutting process. The set of scales 8 is a dynamic set of scales because the weight of the respective portion has to be performed as said portion is being conveyed to the associated packaging machine 10. A loading device which places the respective portion into a packaging recess which is conveyed along the packaging machine 10 is arranged upstream of the packaging machine. The respective portion is packed into a package in the packaging machine 10 and then once again weighed using the checkweigher 11. The checkweigher 11 is recommended by the regulations for prepacked goods.

FIG. 1 shows the line according to the invention. According to the present invention, the respective block of food can be initially weighed, but is preferably not weighed but rather immediately loaded into the scanner 1, in this case an irradiation scanner 1, without the precise weight of said block of food being known, and then conveyed through the irradiation scanner 1, preferably an x-ray scanner, using a feed belt. The product is scanned slice by slice in the scanner. After the block of food has been scanned, it is loaded into the cutting apparatus 2 by means of the feed conveyor belt. A person skilled in the art will understand that the scanner can also be part of the cutting apparatus. There is preferably also no set of scales between the scanner 1 and the slicer 2, or the cutting blade of said slicer, in the cutting line according to the invention. The data which is acquired by the irradiation scanner is then transferred either directly to the cutting apparatus or to another control unit/CPU where it is further processed if required. The cutting process in the cutting apparatus is now controlled on the basis of the data which is acquired during scanning such that portions of as precise a weight as possible are produced. After cutting, the respective portions of food, which are generally mads up of several slices of food, are transferred to a loading apparatus 3 which places the respective portion into a packaging recess which is conveyed along the packaging machine 4. According to the invention, no set of scales which determines the weight ox the respective portion is located between the cutting apparatus 2 and the packaging machine 4. The respective portion is packed into a package in the packaging machine 4 and then weighed for the first time using the checkweigher 5. The checkweigher 5 is recommended by the regulations for prepacked goods in order to ensure that said regulations have been complied with and to document this compliance. The signal from the checkweigher 5 is preferably used to control the cutting apparatus, to calibrate the irradiation scanner and/or to calculate the length of the length which is to be cut from the next block of food for each portion. By way of example, a weighting factor for the next block of food which is to be cut can be calculated using the signal from the checkweigher 5. To this end, all of the weights of all of the portions of a block of food can be added up and transferred to the control unit/CPU which is connected to the scanner and/or to the slicer. Particularly when cutting is performed in several lanes, it is advantageous when the movement of a portion within the cutting line is tracked, so that the data which is acquired from the set of scales can be clearly assigned to a block of food and/or to a specific cutting lane of the slicer, and this movement can then be controlled, for example, in a targeted manner when the measured weight is not close enough to the target weight.

### Exemplary Embodiment

In this example, no set of scales for determining the weight of the block of food is provided upstream or downstream of the scanner.

1. The weight W of the first block of food is estimated or weighed and the weight is stored in a control unit/CPU.

2. The block of food is conveyed through an X-ray scanner 1. The X-ray scanner takes a split shot of the block of food, for example every 0.1 mm. The width of the split is set, for example, by the speed at which the block of food passes through the X-ray scanner and/or the frequency of the shots.

3. The X-ray scanner determines, for example, n=5000 data items, p_{i,i=1-n}. The determined values p_{i,i=1-n} are dependent on the local X-ray absorption of the block of food and are, for example, pᵢ=83,234, p₂=83.334, p₃=83.244. The values are stored, individually and as a function of their position along the longitudinal axis of the block of food, as a curve in a computer unit which is connected to the X-ray scanner. The values are integrated with respect to the width of the respective scan slice.

4. All 5000 values are then added (e.g. 416325).

5. The weighting factor k is determined from this sum P and the weight w of the block of food: 416325/2000 g=208.16.

6. This weighting factor k is used to determine how high the measured value number of a portion with a target weight of, for example, 150 g has to be, (208.16*150=31.224).

7. The curve p_{i,i=1-n} (x) is now integrated until the desired measured value number (31224) is reached. This gives the length which is to be cut for each portion in each case. This process is preferably repeated piece by piece until the entire block of food is divided into portions of the desired weight.

8. While this calculation is being performed, or after said calculation, the scanned block of food is transferred to the slicer and there cut into several portions (for example 13) on the basis of the acquired data, wherein each portion contains several slices of food.

9. Each portion is then transferred to the packaging machine 4 and packed.

10. Each package is then weighed using the checkweigher 5.

11. The data relating to all of the weights of all of the packages which are cut off from one block of food are added and, after the weight of the packages of the portions has been subtracted, give the weight W of the block of food which has just been cut, wherein the initial cut and an end piece which each have not been packed in a package preferably remain left out of consideration.

12. This weight is now used to calculate the weighting factor k of the next block of food by the individual scan values p_{i,i=1-n} of said block of food but the weight W of a preceding block of food being used. Step 1 can therefore be dispensed with in the case of the second block of food or once the total weight of ail of the portions which are obtained from one block of food has been determined.

13. As an alternative or in addition, the individual weights or the total weight are/is used to calibrate the irradiation scanner and/or the evaluation apparatus.

### LIST OF REFERENCE SYMBOLS

1 Scanner, irradiation, X-ray scanner

2 Cutting apparatus, slicer

3 Loading apparatus

4 Packaging machine

5 Checkweigher

6 Scanner, irradiation, X-ray scanner

7 Cutting apparatus, slicer

8 Set of scales

9 Leading apparatus

10 Packaging machine

11 Checkweigher

What is claimed is:

1. A line for cutting blocks of food comprising:
a scanner that acquires data about an internal and/or external structure of each of the blocks of food,
a cutting apparatus that divides each of the blocks of food into portions based on the data from the scanner and,
a loading unit for automatically or manually placing the portions into packaging recesses in a packaging machine, the packaging machine packs the portions into a package,
wherein no set of scales are provided between the cutting apparatus and the packaging machine.

2. The line as claimed in claim 1, wherein a checkweigher that determines a weight of the package is provided only downstream of the packaging machine.

3. The line as claimed in claim 1, wherein a checkweigher that determines a weight of the package and transmits a signal for calibrating the scanner and/or for controlling the cutting apparatus to a computer unit is provided downstream of the packaging machine.

4. The line as claimed in claim 1, wherein the line has a means with which movement of the portions within the line can be tracked at least in sections.

5. The line as claimed in claim 1, wherein the line has a means with which movement of the blocks of food within the line, between the scanner and the cutting apparatus, or both can be tracked at least in sections.

6. The line as claimed in claim 1, wherein the line has a computer means which at least temporarily stores and/or further processes the data from the scanner.

7. The line as claimed in claim 1, wherein the cutting apparatus cuts several of the blocks of food at least temporarily at the same time.

8. A method comprising:
cutting blocks of food precisely in respect of weight using a line, the line having:
a scanner that acquires data about an internal and/or external structure of each of the blocks of food,
a cutting apparatus that divides the blocks of food into portions based on the data,
a loading unit for automatically or manually placing the portions into packaging recesses in a packaging machine that packs the portions into a package, and
a checkweigher provided downstream of the packaging machine that determines a weight of the package,
wherein a signal from this checkweigher is used to control the cutting apparatus and/or to calibrate the scanner for a next block of food to be cut.

9. The method of claim 8, wherein several blocks of food are cut at the same time.

10. The line as claimed in claim 2, wherein the checkweigher transmits a signal for calibrating the scanner, for controlling the cutting apparatus, and/or for calculating a weighing factor of a next block of food to be cut.

11. The method of claim 8, wherein an initial cut and an end piece cut are not packed in the package.

12. The method of claim 8, wherein the line is free of scanners for determining a weight of the blocks of food upstream or downstream of the scanner.

13. The method of claim 8, wherein the data is dependent on local X-ray absorption.

14. The method of claim 8, wherein the signal from the checkweighter is used to calculate a length that is to be cut from a next block of food.

15. The method of claim 8, wherein the line is free of scales between the cutting apparatus and the packaging machine for determining the weight of the portions.

16. A line for cutting one or more blocks of food, the line comprising:
a scanner that acquires data about an internal and/or external structure of the one or more blocks of food;
a cutting apparatus that divides each of the blocks of food into portions based on the data from the scanner;
a loading unit for placing the portions into packaging recesses;
a packaging machine that packs the portions into packages; and
a checkweigher provided downstream of the packaging machine for determining a weight of the packages,
wherein a signal from this checkweigher is used to calibrate the scanner for a next block of food to be cut, and
wherein the line is free of scanners upstream or downstream of the scanner for determining weight of the blocks of food.

17. The line of claim 16, wherein the signal from the checkweighter is used to calculate a length that is to be cut from the next block of food.

18. The line of claim 16, wherein the scanner acquires data about a local density of the one or more blocks of food.

19. The line of claim 16, wherein an initial cut and an end piece cut are not packed in the packages.

20. The line of claim 16, wherein the line is free of scales between the cutting apparatus and the packaging machine for determining the weight of the portions.
